(19) United States
(12) Patent Application Publication
(10) Pub. No.: US 2007/0294250 A1
(43) Pub. Date: Dec. 20, 2007

(54) Method and system for customizable and intuitive content management on a limited resource computing device such as a mobile telephone

(75) Inventors: Natan Linder, Motza Illit (IL); Eyal Toledano, Kiryat Ata (IL); Kim Michael Lee, Herzlia (IL)

Correspondence Address: Martin D. Moynihan;PRTSI, Inc., P.O. Box 16446, Arlington, VA, 22215, US

(73) Assignee: Sumsung Electronics Co., Ltd., Gyeonggi-do (KR)

(21) Appl. No.: 11/812,480

(22) Filed: Jun. 19, 2007

Related U.S. Application Data
(60) Provisional application No. 60/814,586, filed on Jun. 19, 2006.

(51) Int. Cl. G06F 17/30

(52) U.S. Cl. 707/6

(57) ABSTRACT

A customizable, intuitive content management front end is provided for a mobile communication device having limited computing resources. The content comprises multiple content items in several different content types. The apparatus comprises an environment management unit operative to support an environment, typically a three-dimensional environment, as a display on said screen resource. The environment is part of a front end application for the device. An object support unit supports placement of objects into the three-dimensional environment, and an association unit content types with the various objects, such that items of a given content type are accessible via a respective object. Individual content items of the given type are then selected either randomly, semi-randomly or manually for the object.

### RELATIONSHIP TO EXISTING APPLICATIONS

The present application claims the benefit of U.S. Provisional Patent Application No. 60/814,586 filed on Jun. 19, 2006, the contents of which are hereby incorporated by reference.

### FIELD AND BACKGROUND OF THE INVENTION

The present invention relates to a method and system for customizable and intuitive content management on a limited resource device and, more particularly, but not exclusively to such a system for content management on a mobile telephone.

Currently, users of mobile telephones and like communication devices tend to lose track of content and information as there is an abundance of incoming content to mobile phones these days. Thus it is not unusual for a user to receive 500 SMSs per day, and users tend to lose track of information.

Also, known interfaces for mobile telephone devices are well-defined and inflexible, and their scope for making content more accessible is strictly limited.

There exist mobile telephones which have a front end application, a game or the like which adds an element of fun to the device. Other mobile telephones simply have front end menuing systems. Either way, the scope for managing content as opposed to mere storage of the content in a way defined by the front end application does not exist.

Furthermore, mobile telephone devices have relatively small screens, especially as compared with PCs and the like. Such small screens are intrinsically problematic, in that efficient management of data is difficult due to display space restrictions.

Currently, there are no known solutions in the industry for managing large amounts of phone content

### SUMMARY OF THE INVENTION

According to one aspect of the present invention there is provided apparatus for intuitive and customizable content management on a mobile communication device having limited computing resources, the content comprising a plurality of content types and each type comprising a plurality of content items, the apparatus comprising:

a processor,

a display resource, and

a memory resource,

the apparatus being configured with:

an environment management unit operative to support an environment as a display on said screen resource,

an object support unit for supporting placement of objects into said environment, and

an association unit for associating content types with respective objects, such that items of a given content type are accessible via a respective object.

According to a second aspect of the present invention there is provided a method for content management on a mobile communication device having limited computing resources, the content comprising a plurality of content types and each type comprising a plurality of content items, the method comprising:

supporting an environment as a display on said screen resource,

supporting placement of objects into said three-dimensional environment, and

associating content types with respective objects, such that items of a given content type are accessible via selection of a respective object.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified diagram showing a mobile telephone adapted for providing customizable and intuitive content management in accordance with a first preferred embodiment of the present invention.

FIG. 2 illustrates a grid structure on which a three-dimensional scene can be constructed as part of a three-dimensional environment for embedding of content items using content management in accordance with the embodiment of FIG. 1.

FIG. 3 illustrates the incorporation of an image onto a three-dimensional geometry to create an object for use with content management according to a preferred embodiment of the present invention.

FIG. 4 illustrates a browser application for use with the object of FIG. 3 to allow content management according to a preferred embodiment of the present invention.

FIG. 5 is a simplified flow chart illustrating how different content items can be combined together in a clip using the objects of a preferred embodiment of the present invention.

FIG. 6 illustrates a possible scene in a 3D environment according to a preferred embodiment of the present invention.

FIG. 7 is a simplified flow chart that illustrates the process of defining an object and associating a content type or item with the object, according to a preferred embodiment of the present invention.

FIG. 8 illustrates a content item that can be managed intuitively using a preferred embodiment of the present invention.

FIG. 9 is a simplified functional diagram illustrating the process of assigning a given content item to an object in a scene, according to a preferred embodiment of the present invention.

FIG. 10 is a block diagram of a traditional interface to media playing objects according to the prior art.

FIG. 11 is a diagram of a scene in a three-dimensional environment showing media playing objects embedded therein in an intuitive manner, according to a preferred embodiment of the present invention.

FIG. 12 is a simplified block diagram showing the relationship of the content manager application to the operating system and the media programs of the device, according to a preferred embodiment of the present invention.

FIG. 13 is a simplified diagram of a three-dimensional scene to which objects may be attached for embedding of content according to a preferred embodiment of the present invention.

FIG. 14 is a simplified diagram of the scene of FIG. 13, showing the designation of active areas for embedding of content according to a preferred embodiment of the present invention.

### DESCRIPTION OF THE PREFERRED EMBODIMENTS

The present embodiments comprise an apparatus and a method for an automatic, personalized presentation method that allows users to manage their content more efficiently. Management is accomplished by taking the known content and placing it into designated places in the interactive application or game environment which forms the front end of the telephone, so that the content itself becomes incorporated in intuitive ways into the front end.

The preferred embodiments address the technical problem of how to code-assign any content to the design plan of an application or game. They find a way to make the user experience more unique and individual. They also provide a way to utilize the users digital content as part of a program or game.

The preferred embodiment comprises a content management application,—an interactive Content Manager that utilizes content stored on the user's phone and incorporates both the content data and functionality into the telephone's front end application, be it an environment or a game with a built in environment. Data can include SMSs, photographs, illustrations, music files and video. Functionality can be defined as, for example, the phone book function of the telephone and its representation, so that the phone book application can also be incorporated into the environment. The user's content and the telephone functionality become part of the world which surrounds the user in the front end application or game, therefore enhancing the user experience.

A user can create his/her own user interface. The interface can be a classic interface, or a user personalized interface, even based on 3D, as illustrated hereinbelow. The interface can be based on photographs or illustrations belonging to the user or can be part of the environment of the front end application as provided or can be adapted by the user from what is provided.

The user is guided through the application/game by a cursor object. In the front end application for mobile telephones known as My Pet, provided by Samsung, the cursor object is the pet. Sounds, photos, color theme, video, animation, MP3 and textual feedbacks on the user's phone are customized by the user and connected, or embedded into, the front end application in designated locations on the environment, as will be explained in greater detail below. This placing of content data is made into metaphorical objects on the screen, a metaphorical UI, or MUI. The use of intuitive images for the objects, say a loudspeaker for representing music content, or a newspaper or book for representing text, allows the user to manage content data and functionality in an intuitive way.

In order to embed the content in a way in which it can be utilized easily through the locations and objects, a code is created which follows the path from the list, such as the MP3 music list, in which the content is actually located, to the specific, designated location and associated object, for example a radio in the living room of the environment.

Embedded information can also be sent to a friend as a line of code representing the path from the list to the specific, designated place. For example, two users who use the same environment and content need not send a picture of the whole scene. Rather the user need send only the code's description of the scene, since the scene itself is predefined on both the user's and the recipient's phones. Thus sophisticated interaction is enabled without transmitting a large amount of data.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

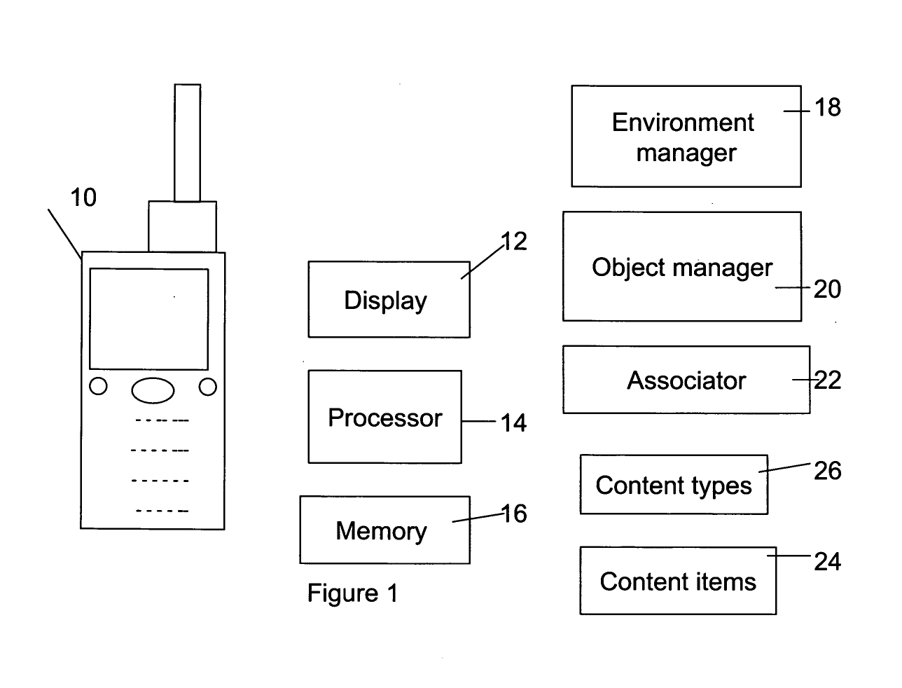

Reference is now made to FIG. 1. which is a simplified diagram illustrating apparatus for content management on a personal computing device 10 such as a mobile communication device or other device having limited computing resources. Such a device would typically be a mobile telephone or a palmtop or notebook type device whether or not the latter have communication capability, or any other substantially pocket sized device. Due to the design constraints imposed by personal portability the device is lightweight and of limited size and therefore is limited in the kind of processor, the amount of memory and the dimensions of the display screen. Illustrated is a mobile telephone but this is purely exemplary. The type of content it is intended to manage includes media content having several content types. For each content type numerous actual content items may be stored on the personal computing device and current systems for managing the content items on such a personal computing device are not intuitive.

Device 10 includes a processor 12, a display resource 14, and memory 16, and the apparatus is configured with an environment management unit 18 which supports an environment, typically a 3D environment and displays the environment on the display resource 14. The environment constitutes a front end for the device and may be part of a game.

In addition an object support unit 20 supports the definition and placement of objects into the three-dimensional environment, and an association unit 22 associates content types with respective objects, so that items 24 of a given content type 26 are accessible via selection of the associated object. That is to say data items, typically media items of different kinds, are stored on the device 10, and are organized using the objects so that media items of the same type are accessed through the same object. The object is placed within the environment, so that the various content items can be accessed intuitively by the user.

In use the environment management unit 18 is designed to allow individual users to construct their own user-customized environments, so that the environment as a whole is one that the user is comfortable with, possibly including a scene of his own choosing with objects of his own choosing.

In one embodiment, content items of a given type that are associated with an object are randomly chosen to appear at the object. Thus if the object is examined at a given time, then the content item randomly selected at that time will be played. The user thus encounters his familiar content items but in unpredictable ways. Selection of content items is discussed in greater detail hereinbelow.

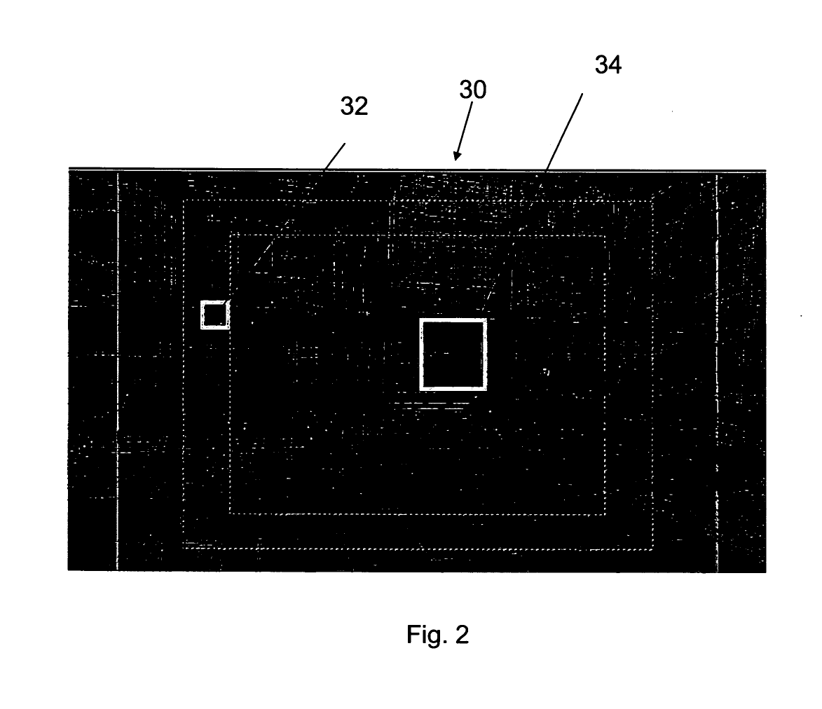

Reference is now made to FIG. 2 which shows a grid 30 that forms the basis of a three dimensional environment. Within the grid, bounding squares 32 and 34 are selected to define active regions, that is regions that can be selected to access media. The active regions are associated with an image so that the user has an image, preferably suggestive of the content type, on which to click. The environment unit thus has the task of defining a two dimensional active location on the three-dimensional environment, and the further task of placing an image at the two-dimensional active location. The image in combination with the active location comprises the object.

The image may be a user-provided image. As a result the objects can give the user a more personal feel. Alternatively or additionally the image may be one that has an intuitive association with the content type with which it is associated.

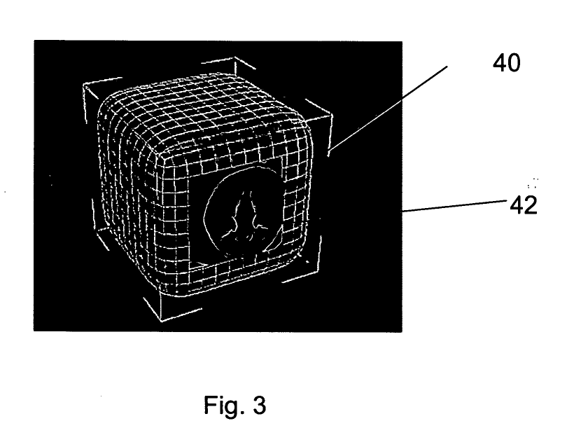

Reference is now made to FIG. 3, which is a simplified diagram illustrating a variation of the present embodiment in which the object is three-dimensional. Instead of the active region being based on a two-dimensional boundary, a three-dimensional shape is used such as cube 40. The cube is used to define a three dimensional active location within the three-dimensional environment, and then an image 42 may be superimposed as texture on the three-dimensional active location. Again, the image may be provided by the user and may provide an intuitive connection with the content type with which the object is associated.

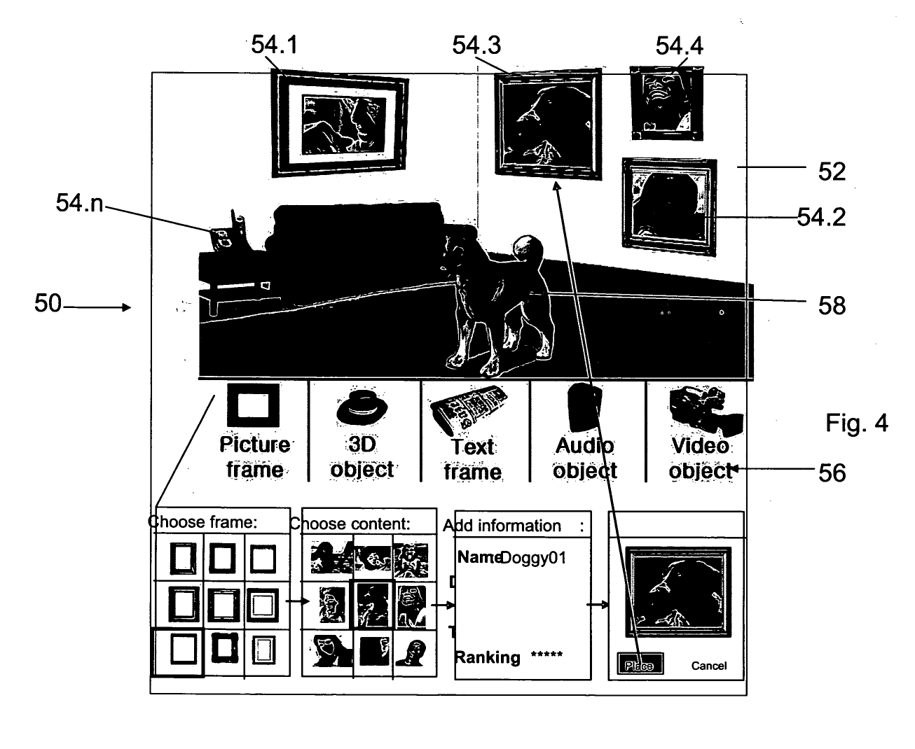

Reference is now made to FIG. 4, which is a simplified diagram illustrating a graphic based browser 50 that allows users to manage their media items, objects and their personalized environment. The browser displays the environment itself in a first window 52. The environment includes objects 54.1, 54.2 . . . 54.n. Each of these objects can be selected to open a content item associated with the object. Item 54.3, is a photo of a dog, and may have been taken from a folder of other photos, possibly associated with the photo of the dog in some way. The object could be associated with all the photos on the telephone or perhaps just with photos from that folder. A single photo from the folder is displayed on the object at any given time. The photo displayed may be selected at random or manually as preferred.

The picture display object is here comprises a frame which is placed in the environment. Attributes can then be added to the object as will be explained on greater detail below.

The browser shows a row 56 of objects of different types. A picture frame indicates still pictures, a 3d object indicates 3d still pictures. A newspaper indicates text objects. A speaker indicates audio objects and a cine camera indicates video objects. Any of these can be placed in the environment and associated with different media items of the respective type.

The browser both allows objects to be set up in the environment, and for content items to be associated with the objects.

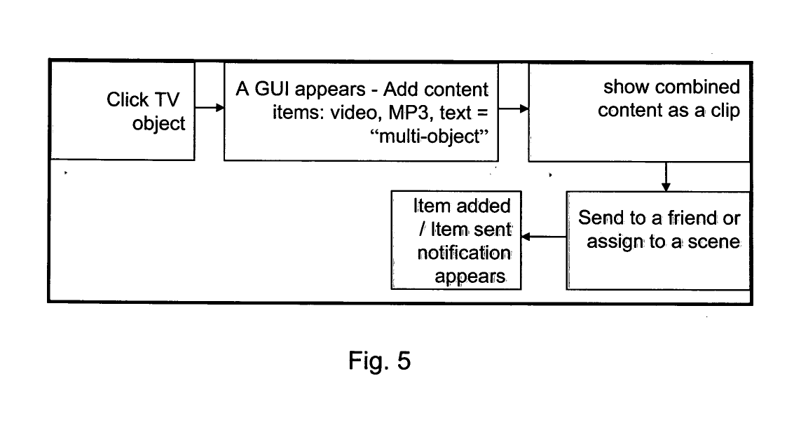

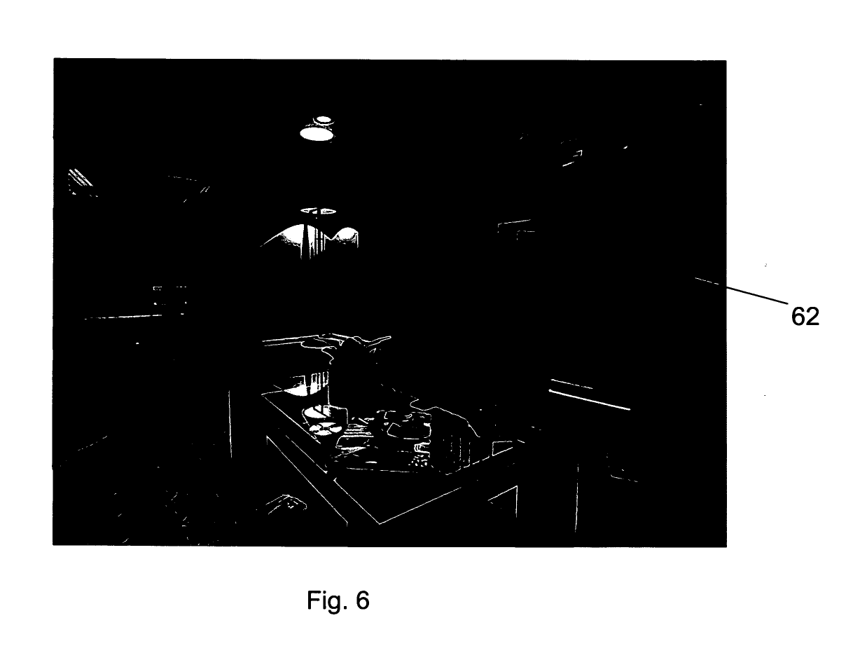

It is also possible to define an association object, that is an object that takes media items of different kinds and associates them together. For example a user may define a karaoke object which stores a musical track in association with a text item carrying the lyrics of the song. The two content items, music and lyrics, can then conveniently be accessed together, or for that matter moved together or downloaded or uploaded together. An example of use of such an association object is illustrated in FIG. 5. A TV object (item 62 in FIG. 6, is used as the association object and allows a combination of video, music and text items. The TV object is selected, and a graphical user interface (GUI) appears to allow the content items to be added. The combined content is then played as a clip, and may be stored, assigned or sent out as desired. An acknowledgement is then made by the GUI of the ultimate fate of the clip.

In one implementation, the association unit that associates content items with each other and with objects does so using multipurpose Internet Mail Extensions (MIME).

An interaction unit may allow objects to interact with each other. Thus an animated character on the screen, such as dog 58 may have interactions defined with certain objects and its content types. For example the character may interact with a text object by reading out selected text content.

The object manager supports the object in accordance with its attributes. Objects may be given many kinds of different attributes. For example an object could be supplied with a lifetime attribute. A text object for example could be set with a lifetime to ensure that SMSs are only stored for a certain maximum time. A user could for example define two text objects, one for SMSs to be kept only for a limited time and a second text object for keeping SMSs indefinitely. The user would then manually assign arriving SMS messages to the appropriate object.

Dog 58 in the example of FIG. 4 constitutes a cursor object. The cursor object provides for navigation around the environment, and a means for the user to interact with other objects in said environment. The skilled person will be aware that both simpler and more complex cursor objects are possible. The cursor object 58 comprises an animated character having lifelike behavior, but a simple arrow could be used as an alternative.

The communication apparatus has communication ability. In one embodiment the cursor object can be downloaded to another computing device, to provide interaction with the other computing device.

An example of such interaction includes using the downloaded cursor object to select content items from the other computing device for communication back to its home device.

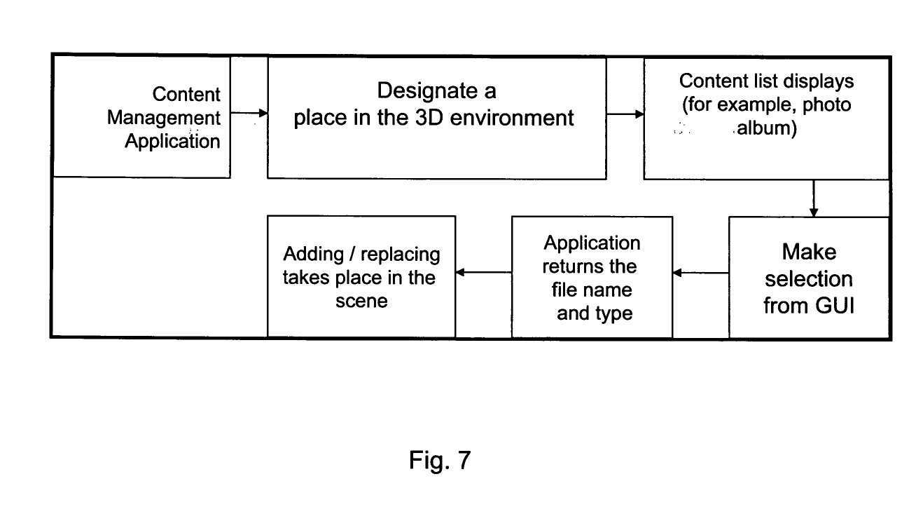

Reference is now made to FIG. 7, which is a flow chart illustrating a method for content management on a mobile communication device having limited computing resources. The content comprises any one or several different content types and each type comprises one or more content items.

An environment, typically a 3D environment is set up or otherwise provided. The environment is displayed on the screen of the limited resource device. Placement is made of objects into the three-dimensional environment by selecting a location in the environment as an active location. The object is associated with a content type, say photographs. Content items of the respective type are displayed via the graphical user interface and can be selected for the object. Other content items can be removed from the object. The result is an object that has associated with it a sub-set of the content items of the corresponding type. The associated content items are then accessible via selection of the respective object.

The present invention will now be illustrated in association with a mobile phone application that involves a pet animal as an avatar, such as provided in the My Pet front end/game application of Samsung. The avatar exists within the environment of the present embodiments and allows users to interact with the environment. User are able to see and hear items of their own personal content as they are placed into various embedded graphical objects in the various scenes.

As described above, objects are defined by the user and associated with multiple media items. However any of the media items associated with the object may be displayed at any given time and the process of exchanging content may be automatic and even random. For example, the user may see his/her photo appear in a picture frame object on the wall, and then be exchanged with another photograph. Likewise the user may see text emanating from a newspaper sitting on a table, or for that matter from a tattoo of an animated character. The content medium becomes embedded and accessible from the metaphorical objects. Thus the user moves the cursor object—the dog—to the text object and unless the user deliberately selects a text, a random text may be chosen and displayed or read.

The above-described integration of personal content into the pet-based application in an automatic/random manner provides an element of surprise and intrigue, therefore making each session unique.

Content as referred to herein concerns any attachable visual or audio item which the user has created, acquired, or collected—whether actively or passively, such as incoming or outgoing SMSs, photos, sounds, texts, MP3s, videos, color theme, and ringtones.

The browsing interface of the application enables the user to specify which content can be used by the application. Indeed the user may define not only which content is used but also which content may not be used. The allowable content goes into content galleries for the respective objects. Unspecified content may be allowed according to the application's default definitions or according to specific request by the user.

As explained above, the application enables content sharing between different users through communication between the different phones. Bluetooth™ and like communication protocols enable searching for and collecting content from a friend's phone within a certain radius, with the friend's approval of course. If granted permission, a user can peruse his/her friend's content galleries, and choose what content to download.

In the same way an option may be provided to download content resources to the user's phone directly from a PC via Bluetooth™ or the like. For example the cursor object, here a 3D dog, may be sent via Bluetooth to a nearby PC where it appears as wandering on the PC screen in animated fashion. Then, by clicking the dog, it acts as a link, so that the user can view his/her own content, upload more content from the PC onto the phone, and also download from the phone to the PC.

Thus, by placing a folder containing pictures and sound onto the cursor object, the folder may be uploaded to the phone's Content Management application. The MIME headers reveal the type of content so that the appropriate local content folder can be found or the user can decide to put some content in the Favorites folder initially, or afterwards.

The following are a list of some of the many possible items, with a description of possible places to be randomly played/presented in the scene:
Sounds: Sounds such as ringtones can be randomly played in response to a user-initiated sound command. The user may ring a virtual door bell in the environment, thereby to activate a random sound.
MP3: MP3 files can be attached to and played by a radio or a music player object in the scene.
Texts: Texts such as SMS can be attached to and presented by objects in the scene, such as a newspaper, street sign, clothes, book, poster and flyer.
Videos: Videos can be attached to and played by objects in the scene, such as a TV set or a billboard.
Photos: Photos, for example taken by the phone's camera, can be attached to or presented by frames hanging on the wall, posters, commercial signs, clothes, vehicles and other objects.
Animations: Animations can be attached to or played by objects such as signs and clothes.
Colors: Color themes can be applied according to or in replacement of the phone's existing color theme.
Fonts: A font object can allow for selection of a font as well as size and color definitions for the font.

As explained above, there is a possibility of associating multiple content items to output a multi object such as a clip. The idea is to form a clip by connecting several content items together. As explained above with respect to FIGS. 6 and 7, a clip involving multiple content item types can be created by defining the content items together. An object can be defined as a multiple type object, for example TV object 62 can have the following items attached in association with each other: a video clip, an MP3 file and the text of a prior SMS. The association under the auspices of the object creates a new multi-item, which can be saved and also sent to other users.

In the context of the object, the user can build a multi-item in a specific way by prioritizing the placing of content. Content items may be comprised of various levels, a level per content item, whether sound, images, etc. There can even be various levels for the same item type. Thus it is possible to provide a montage item say comprising a background image and a foreground image. Alternatively a music video clip could be constructed in which level 1 is furnished by the video, level 2 would be a picture, shown as a background to the video which is played in the foreground, and level 3 would be the sound. Thus the multi-object allows the user to define the different levels and the content types to be associated with each level.

Features can be applied to a multi-object to allow say making a screen saver from content, or creating a music slide show from pictures and music.

The objects of the Application can have additional content items connected to them, for example via the MIME protocol, such as the date, time, and the name of the original user who created the content.

A clock object could be defined which knows the time. The dog character would interact with it by saying the time whenever the clock object is selected.

At this point a comment is added on the MIME protocol. MIME or Multipurpose Internet Mail Extensions (MIME), is documented in RFC 1521 and RFC 1522, and defines a standard representation for complex message bodies in electronic mail. A complex message body is one that does not conform to the default of a single, human-readable, ASCII mail message. Examples of complex message bodies include messages with embedded graphics or audio clips, messages with file attachments, messages in Japanese or Russian, or signed messages.

MIME defines several new header fields—Mime-Version (identifying a MIME document), Content-Type, Content-Transfer-Encoding. The Content-Type header field includes a definition of the type of the content and comes in seven pre-defined types, each of which have subtypes. An extension mechanism exists for defining new types and subtypes. The Content-Transfer-Encoding defines several encoding mechanisms for binary data that may otherwise be difficult to transport.

Advertisements can be added into the application. For example, the Samsung logo could be put on designated areas of objects, etc.

Referring again to FIG. 2, a room can be infinitely co-tangible, meaning it can be totally customizable. One can divide a room into small or large sections, each of which can be customized and defined by the user.

For every individual area, or square, on the grid, the user can designate content item(s)—square 32 is such a square, or the user can designate the content to multiple squares covering a larger area—see multiple square 34.

The text/pic/mp3/sound content items can for example be assigned to multiple square 34. The user can even custom-designate and configure content for an entire room. By doing this, the user can even reproduce, for example his/her own room into the application/game. This can be achieved on the phone, as well as on a PC.

The user can assign one photo to a designated location. Thus the designated location displays the single assigned photo. Alternatively an entire folder comprised of many different photos can be assigned to a single location as a content entity. The definition of the specific location used, in terms of its size, defines the size and crop values of the content items to be displayed thereby.

When a folder of items is associated with a single object then the different items could be displayed one after the other in sequence or selected at random. Alternatively an entire wall or like large region could be associated with the photo album and a wall paper may be created which is a composite of all or some of the pictures from the folder, thus allowing simultaneous display of multiple items.

In a 3D environment, a 2D bounding box, such as 32 and 34, is used to define the content entity's area. First the environment or scene itself is created, and then a map of the scene is created. Active areas for assigning content may be designated in the scene. The active areas may be achieved by the use of 3D bounding boxes. The 3D bounding box may be made of spheres of 3D coordinates. Objects are added and removed by detecting the collision of pixels between 3D/2D bounding boxes and between the objects to be added. FIG. 6 is an example of a room with objects designated by the user.

Referring again to FIG. 3, which shows texture added to a 3D geometric entity, the user can also designate content to a 3D object in the same manner as assigned to a 3D environment. By designating content 42 to be attached to an existing 3D shape 40, the user creates a customized 3D object. The user may well wish to assign the object a name. The object can also be sent to a friend.

Referring again to FIG. 4, and an internal browser enables searching the user's own content to connect a content file from the list to the object in the scene. The browser in FIG. 4 is graphic-based although it could also be text-based. By clicking an object in the 3D environment, the browser opens a list of content items. The User can browse content and download it directly from friends. The user can choose the objects (for example, 2D or 3D), texts and functions (such as sort/add) either manually, semi-automatically or automatically.

Objects may be assigned attributes. Some attributes are universal and some less so. Attributes may include name, key, date received or created, time received or created, rank, comment, color, category, and relationship. The object attributes are an integral part of the object, and also of the items associated with the object. Items too may have their own attributes although these need not necessarily become attributes of the object. The item's position in the scene is a link which can be defined. A link may relate the item to another user or another object. The latter would be the case in the Multi-object embodiment.

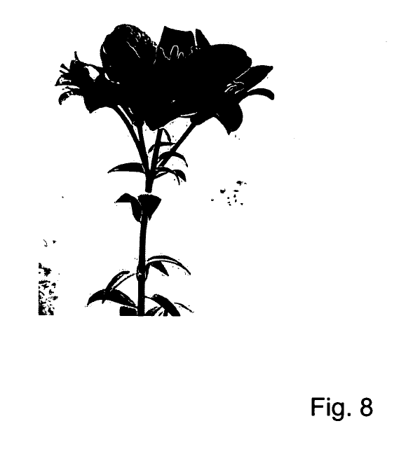

Certain objects or items may even have customized attributes. For example, the item in FIG. 8, a flower, may be set with a customized attribute of a set time limit for its lifespan, just like a real flower. The following more conventional attributes would also be included: the category, a rank, such as a graded scale, a comment, such as boring, interesting etc, relationship, for example a flower received from user's girlfriend may appear as “Amy/Flower B”. Such attributes provide a reality imitating way of giving someone flowers in the virtual world.

An example of an item property list for the item shown in FIG. 8 may be as follows:

Name: flower A

Ranking: ***** (five stars)

Comment: fun picture

User Name/Relationship: Dave

An object may represent items of particular subject matter. For example an album could be set up say for the user's wedding photos. An object representing the subject matter can be drawn, or realistic as preferred, to give the user an intuitive feel for the subject matter and the photos involved are linked to the object. The resource used to create the content items can be, for example, a camera or microphone, etc.

Functions may be assigned to content items or to objects. Such functions may include: create, sort, search, and the function can be automatic, semi-automatic, manual.

In one embodiment the system includes a favorites folder, in which certain favorite content is placed. Location in the favorite folder may be user controlled or may be automatic. In the automatic mode indications such as the rating (ranking) of content by the user or the amount of usage could be used. In the manual mode the user may drag the content into the folder. In either event the content may then show as part of the browser interface.

The Content Management application may take and designate content automatically from the Favorites folder to add into various locations in the application or environment, so that the user now finds his favorite content turning up in unexpected places. From then on however the user can actively manage the content.

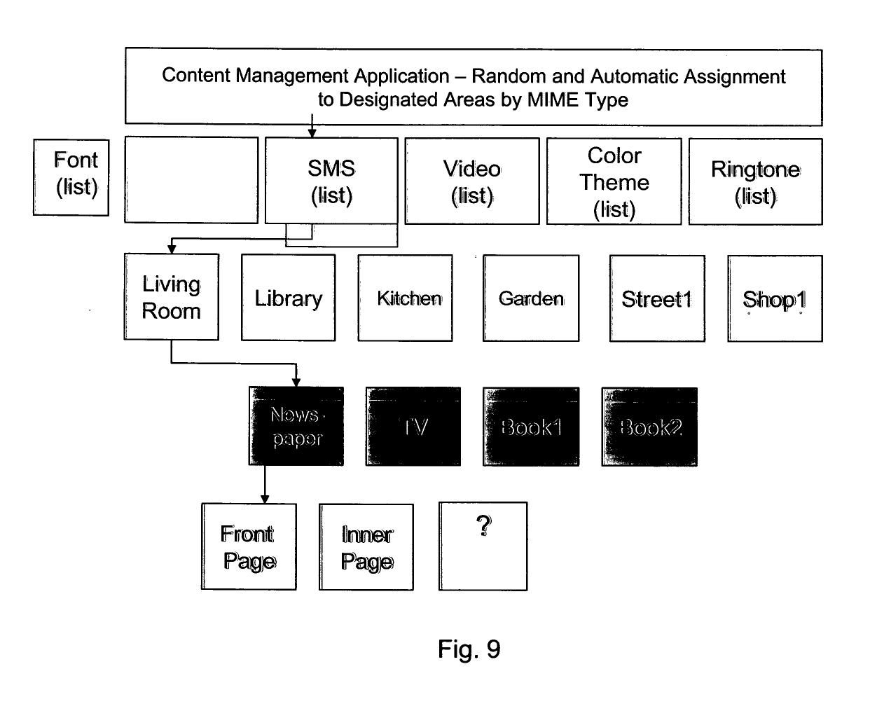

Reference is now made to FIG. 9 which illustrates the procedure in a which a text content item is assigned to a newspaper object 3D Interface. In this case the content management application 90 determines from the MIME header that a content item is a text message. The item is assigned to a list of SMS messages. In this case the user has a 3D environment that consists of several scenes—the different rooms of a house and the surroundings of the house. The content item is associated with one of the scenes, in this case the living room. The content item is then associated with an item in the living room, in this case a newspaper. As a further refinement the newspaper has multiple pages, and association of the content item is with a specific page of the newspaper, say the front or back page or an inner page.

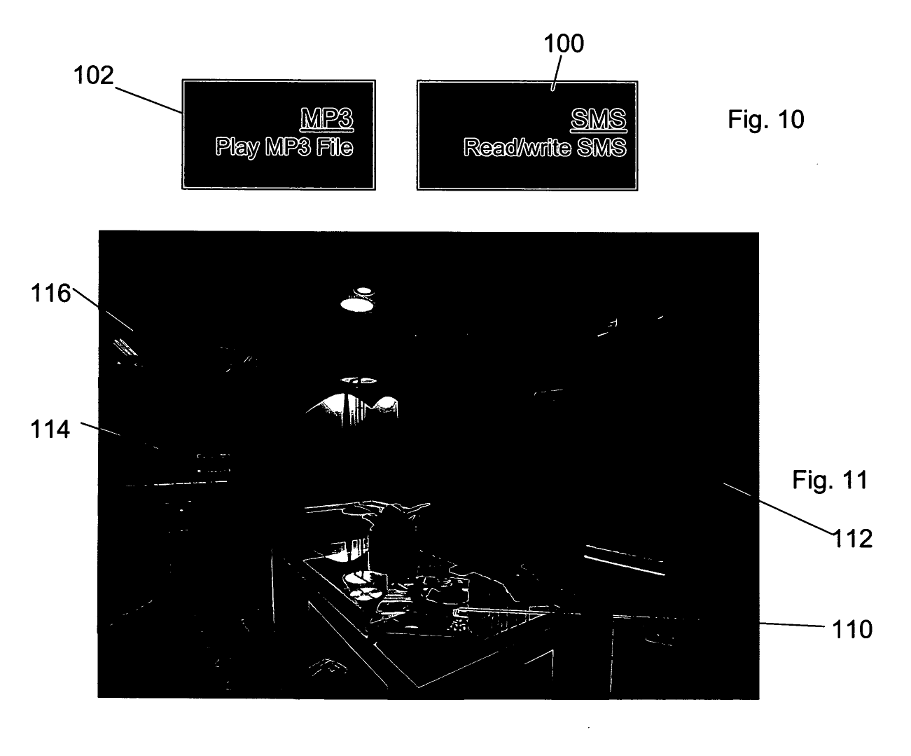

Reference is now made to FIG. 10, which illustrates existing interfaces for an MP3 player 100, and for an SMS reader 102.

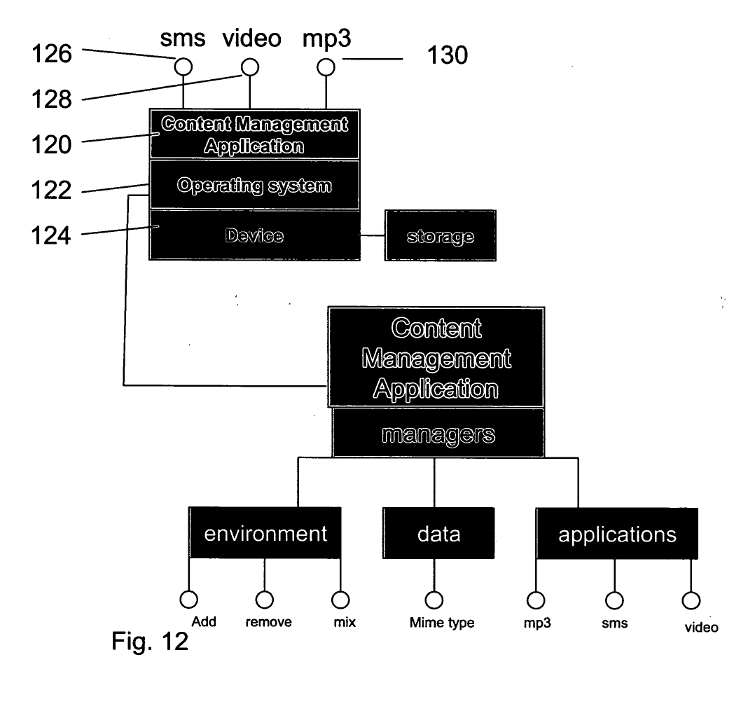

Reference is now made to FIG. 11, which illustrates a visual interface according to the present embodiments in which the user selects objects in the 3D environment to activate the respective functions. The SMS reader is represented by magazine 110, the television 112 represents a video player. The music center 114 represents an MP3 player and the picture frame 116 represents a picture display. Thus for example, by metaphorically clicking on the newspaper, the user can read an SMS, and by clicking on the TV, the user can view a video).

Reference is now made to FIG. 12, which is a simplified block diagram illustrating a schematic structure for a preferred embodiment of the content management application. The content management application 120 is located between the operating system 122 of device 124 and the content applications such as SMS application 126, video application 128 and MP3 application 130. The content application itself comprises a series of manager units, which respectively manage the environment, the data and the content applications.

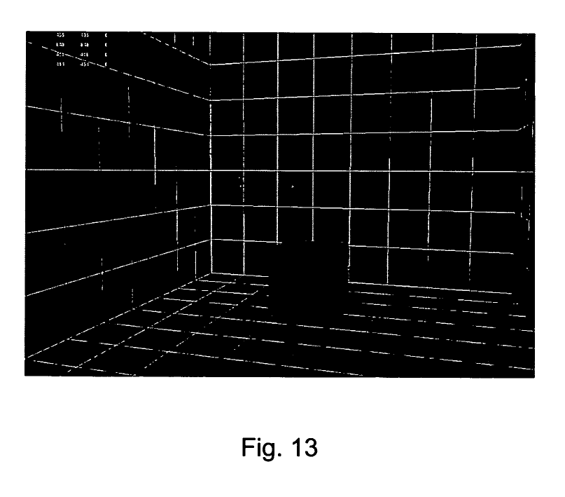

An illustration is now given of the process of adding content to an environment. Reference is now made to FIG. 13 which shows an empty 3D environment without any designated areas.

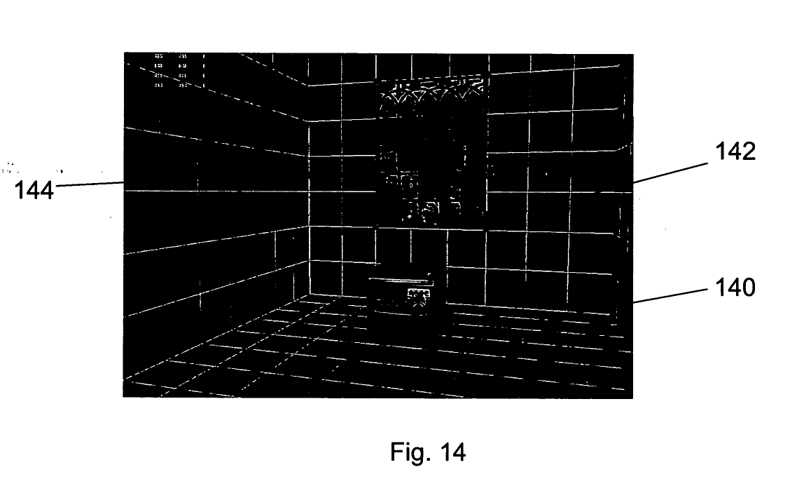

Referring now to FIG. 14, the user selects locations for content designation. By either choosing four points on the grid to define a square 140, 142, or by selecting areas as faces 144, say by dragging the cursor using the shift key, he is able to designate an active area in the environment. The active area can then be assigned an image, preferably an image that intuitively implies the content type.

As discussed above, media items can be associated with the media objects in any one of a number of ways. That is to say the user can link any picture to a selected area in three ways:

1. Automatically—the program uses any picture out of any folder and places it into any destination. Particular folders may be designated for particular objects, or objects can be selected at random from a favorites folder. The user thus finds say photographs appearing at random in his photo frame, or hears music tracks at random when activating the music player.

2. Semi-automatically—pictures are chosen randomly by the software, out of a user-defined folder or folders. For example, the software chooses a content item automatically from folder A, and places the content item into frame A in room A. Using the semi-automatic option the user can define different objects in his environment. He can have an object that plays media with a particular theme. Thus a user can dedicate an object to a recent holiday, or to his girlfriend, or can have his own private objects for media that is for his eyes only. As a further possibility the user may designate different rooms within his environment for objects of different media types but relating to the same theme, so that he has a room for the holiday or for his girlfriend etc. The media objects within each room take media items only from folders associated with the theme, but with that proviso they may then select the media items at random.

3. Manually—In manual mode the user selects a media item and designates it with an area, and media playing object, in the 3D environment.

As mentioned, for content, there are also the following functions:

1. Search—search by name (for a folder, picture, music file, etc.

2. Sort—folder, picture, music file, etc.

3. Create—folder, name

The content management application helps personalize an entire application by bringing the user into the application through utilization of his/her personal visual and audio content. By making the user a central part of the scene, the Content Management Application provides for a more interesting and enjoyable user experience that users can relate to, with each session truly unique.

The program integrates the user's world into his virtual environment, which may be the environment of a game, making every environment unique.

The environment uses original material, the user's content, which can be chosen by the user or assigned automatically by the application.

It is expected that during the life of this patent many relevant devices and systems will be developed and the scope of the terms herein, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. Apparatus for intuitive and customizable content management on a mobile communication device having limited computing resources, the content comprising a plurality of content types and each type comprising a plurality of content items, the apparatus comprising:
a processor,
a display resource, and
a memory resource,
the apparatus being configured with:
an environment management unit operative to support an environment as a display on said screen resource,
an object support unit for supporting placement of objects into said environment, and
an association unit for associating content types with respective objects, such that items of a given content type are accessible via a respective object.

2. Apparatus according to claim 1, wherein said environment management unit is configured to allow construction of a user-customized environment.

3. Apparatus according to claim 1, wherein said association unit is configured such that said content item is accessible via selection of said respective object.

4. Apparatus according to claim 1, wherein said association unit is configured with a random selector to randomly select a content item of said content type for current access via said respective object.

5. Apparatus according to claim 4, wherein said association unit is configured for association of a user defined subset of content items of an associated content type with said respective object, such that content items of said subset are randomly selected.

6. Apparatus according to claim 1, wherein said association unit is configured to allow a user to associate specific content items of said associated content type with said respective object.

7. Apparatus according to claim 1, wherein said environment management unit comprises a three-dimensional environment management unit, and said environment comprises a three-dimensional environment.

8. Apparatus according to claim 7, wherein said object support unit is configured to:
define a two dimensional active location on said three-dimensional environment, and
place an image at said two-dimensional active location, said image at said active location comprising one of said objects.

9. Apparatus according to claim 8, wherein said image is a user-provided image, thereby allowing said objects to be user-customizable.

10. Apparatus according to claim 7, wherein said object support unit is configured to:
define a three dimensional active location on said three-dimensional environment, and
superimpose an image as a texture on said three-dimensional active location, said image at said active location comprising one of said objects.

11. Apparatus according to claim 10, wherein said image is a user-provided image, thereby allowing said objects to be user-customizable.

12. Apparatus according to claim 8, further comprising a browser for simultaneously displaying at least two of:
said environment,
a plurality of images for selection,
a plurality of available ones of said content types,
a plurality of available content items, and
a customization form for entering labels or parameters in respect of at least one member of the group comprising: a content type, a content item and an object.

13. Apparatus according to claim 1, wherein said association unit is configured to define an association object as an object taking associated content items of a plurality of different content types, and configuring said associated content items to be accessed together.

14. Apparatus according to claim 13, wherein said association unit is configured such that said accessing together comprises playing said associated content items together or moving said associated content items together or downloading said associated content items together or uploading said associated content items together.

15. Apparatus according to claim 1, wherein said association unit is configured to use multipurpose Internet Mail Extensions (MIME) in order to carry out said associating.

16. Apparatus according to claim 1, further comprising an interaction unit for managing interactions between objects and a content item not associated therewith.

17. Apparatus according to claim 1, wherein said object support unit is configured to define a lifetime attribute for a respective object.

18. Apparatus according to claim 1, wherein said environment management unit is configured to support a cursor object, said cursor object being for moving around said environment through which to interact with other objects in said environment.

19. Apparatus according to claim 18, wherein said cursor object comprises an animated character.

20. Apparatus according to claim 18, configured with communication ability and wherein said communication ability is configured to allow download of said cursor object to another computing device, thereby to allow interaction of said apparatus with said another computing device.

21. Apparatus according to claim 20, wherein said downloadable cursor object is configured to select content items from said another computing device for communication back to said mobile communication device.

22. Method for content management on a mobile communication device having limited computing resources, the content comprising a plurality of content types and each type comprising a plurality of content items, the method comprising:
supporting an environment as a display on said screen resource,
supporting placement of objects into said three-dimensional environment, and
associating content types with respective objects, such that items of a given content type are accessible via selection of a respective object.

23. Method according to claim 22, further comprising allowing construction of a user-customized environment.

24. Method according to claim 22, wherein said environment comprises a three-dimensional environment.

25. Method according to claim 24, further comprising:
defining a two dimensional active location on said three-dimensional environment, and
placing an image at said two-dimensional active location, said image at said active location comprising one of said objects.

26. Method according to claim 25, wherein said image is a user-provided image, thereby allowing said objects to be user-customizable.

27. Method according to claim 24, further comprising
defining a three dimensional active location on said three-dimensional environment, and
superimposing an image as a texture on said three-dimensional active location, said image at said active location comprising one of said objects.

28. Method according to claim 27, wherein said image is a user-provided image, thereby allowing said objects to be user-customizable.

29. Method according to claim 25, further comprising allowing user operation by simultaneously displaying at least two of:
said environment,
a plurality of images for selection,
a plurality of available ones of said content types and
a customization form for entering labels or parameters in respect of at least one member of the group comprising: a content type, a content item and an object.

30. Method according to claim 22, comprising defining an association object as an object taking associated content items of a plurality of different content types, and configuring said associated content items to be accessed together.

31. Method according to claim 30, wherein said accessing together comprises playing said associated content items together or moving said associated content items together or downloading said associated content items together or uploading said associated content items together.

32. Method according to claim 22, comprising using multipurpose Internet Mail Extensions (MIME) in order to carry out said associating.

33. Method according to claim 22, further comprising managing interactions between objects and a content item not associated therewith.

34. Method according to claim 22, comprising defining a lifetime attribute for a respective object.

35. Method according to claim 22, comprising providing a cursor object, said cursor object being for moving around said environment through which to interact with other objects in said environment.

36. Method according to claim 35, wherein said cursor object comprises an animated character having life-mimicking behavior.

37. Method according to claim 35, comprising downloading said cursor object to another computing device, thereby to allow interaction with said another computing device.

38. Method according to claim 37, comprising using said downloaded cursor object to select content items at said another computing device for communication back to said mobile communication device.
